(19) United States
(12) Patent Application Publication
(10) Pub. No.: US 2022/0329149 A1
(43) Pub. Date: Oct. 13, 2022

(54) POWER SUPPLY WITH HAYSTACK EFFICIENCY

(71) Applicant: Microsoft Technology Licensing, LLC, Redmond, WA (US)

(72) Inventors: Chee Kiong FONG, Saratoga, CA (US); Geoffrey Jason SHEW, Redmond, WA (US); Michael Roy VOLKMAN, Seattle, WA (US); Aaron David BUERMAN, Seattle, WA (US); Andres Felipe HERNANDEZ, Seattle, WA (US); Richard Frederick JOHNSON, Lake Tapps, WA (US)

(73) Assignee: Microsoft Technology Licensing, LLC, Redmond, WA (US)

(21) Appl. No.: 17/229,366

(22) Filed: Apr. 13, 2021

(51) Int. Cl. H02M 3/04; H02M 7/04; H02M 1/44; H02M 1/42

(52) U.S. Cl. CPC H02M 3/04; H02M 7/04; H02M 1/44; H02M 1/4208

(57) ABSTRACT

A power supply may include multiple converters connected in parallel. The power supply may detect a signal that indicates how much power a device uses. Based on the signal, a converter controller may determine which of the multiple converters to activate or deactivate to supply enough power to meet the power load of the device and to operate the highest efficiency possible. The amount of power output from the power supply may be the sum of the power output by each of the converters that is activated. The power supply may use the multiple converters to operate at high efficiency throughout a wide range of power load levels. Such a power supply may achieve a haystack (i.e., near flat) power efficiency curve throughout a large part of its operating range.

### BACKGROUND

Electric power is a limited and costly commodity. Therefore, efficient use of electrical power is important for cost savings and also for the environment.

### SUMMARY

The present concepts relate to power supplies that can provide high power efficiency for a wide range of output load levels by using multiple converters. The power efficiency curve for the power supply can exhibit a haystack shape with a wide near-flat top, thus reducing energy waste experienced by conventional power supplies.

### BRIEF DESCRIPTION OF THE DRAWINGS

The detailed description below references accompanying figures. The use of similar reference numbers in different instances in the description and the figures may indicate similar or identical items. The example figures are not necessarily to scale.

FIG. 1 illustrates a comparison of an example haystack power efficiency curve consistent with the present concepts and a conventional power efficiency curve typical of a conventional power supply.

FIG. 2 illustrates a block diagram of an example haystack power supply, consistent with the present concepts.

FIGS. 3A-3D illustrate example power efficiency curves of multiple converters, consistent with the present concepts.

FIG. 4 illustrates a flow chart of an example converter enable and balancing logic, consistent with the present concepts.

FIG. 5 illustrates a table of example modes of operation of a haystack power supply, consistent with the present concepts.

FIG. 6A illustrates the example power efficiency curves of the four converters in FIGS. 3A-3D superimposed together in one graph.

FIG. 6B illustrates a comparison of the haystack power efficiency curve consistent with the present concepts and a conventional power efficiency curve typical of a conventional power supply.

FIG. 7 illustrates a flow chart of an example power supply method, consistent with the present concepts.

FIG. 8 illustrates an example device, consistent with the present concepts.

### DETAILED DESCRIPTION

Governments and industries around the world are applying pressure to increase power efficiencies and decrease power losses in electronic devices. For example, the European Union began implementing carbon taxes to reduce power losses in consumer electronics. More efficient power use reduces wasted power consumption, which reduces carbon emissions and helps the environment. Higher power efficiency can also save costs associated with generating and using electricity.

However, a conventional power supply utilizes one converter and thus has a bell-shaped power efficiency curve with a peak efficiency near the middle of its operating range. That is, a conventional power efficiency curve includes a hump at the middle of its peak efficiency power output level but has much lower efficiency on either side of the hump. At lighter loads and at heavier loads, iron losses (which may be fixed losses) and/or copper losses (which may be variables losses) can cause the efficiency to drop. Thus, outside of the conventional power supply's peak efficiency range, the conventional power supply operates inefficiently and wastes substantial amounts of power.

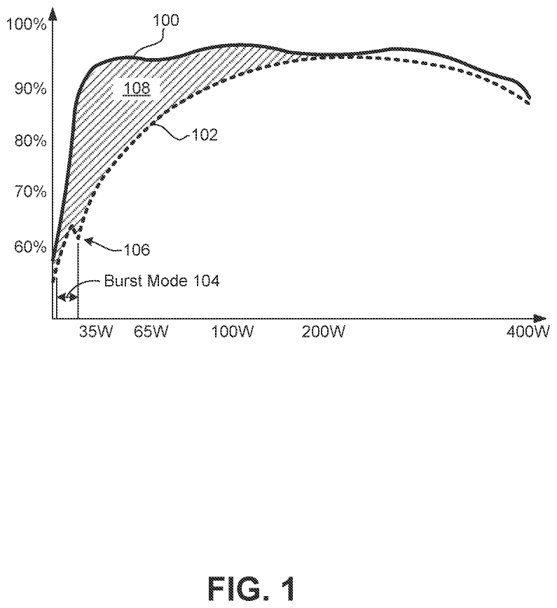

FIG. 1 illustrates a comparison of an example haystack power efficiency curve 100 consistent with the present concepts and a conventional power efficiency curve 102 typical of a conventional power supply. In this example, the conventional power efficiency curve 102 may be for a conventional 400 W power supply that can supply power in the range of 0 W to 400 W. The conventional power efficiency curve 102 may start very low—below 50% or even as low as around 30% or 40%—at a low output load (e.g., 0.5 W), possibly due to iron losses. Then, as the output load increases, the conventional power efficiency curve 102 increases. The conventional power efficiency curve 102 reaches its maximum at the conventional power supply's peak efficiency range of around 200 W to 300 W. Afterwards, the conventional power efficiency curve 102 starts to drop as the output load increases beyond 300 W and 400 W, possibly due to copper losses.

Some conventional power supplies may implement a burst mode operation 104 (or a skip mode or a pulse skipping mode) to improve power efficiency at low output loads (e.g., around 0.5 W). However, there are several drawbacks to the burst mode technique. First, the burst mode operation 104 improves power efficiency only slightly. Second, there is still an undesired efficiency drop 106 at the transition between the burst mode operation 104 and normal operations. And third, the power supply will have to come out of the burst mode 104 if the power demands rise. That is, the burst mode operation 104 can provide power savings only during low power utilization.

There are no conventional power supplies with a power efficiency curve that is almost flat between the minimum load (e.g., around 5 W in this example) and the maximum load. As illustrated by the conventional power efficiency curve 102 in FIG. 1, the iron loss and the copper loss are quite high for a conventional power supply when the load is outside of its peak efficiency range.

This technical problem is exacerbated for bigger power supplies whose maximum load is higher, because the loss is even greater when a big power supply that is capable of outputting high power is operating at low power output. While using a big power supply at low power outputs results in low efficiency, such low-power mode of operation is often necessary in devices with varying power utilization levels. For example, a personal computer (PC) can use lots of power when playing a processor and graphics intensive game or charging a battery but use only a small amount of power when idling or browsing the internet. Similarly, a game console may use high power when playing a game but use low power when playing a movie.

Thus, there is a need to improve the efficiency of power supplies. Specifically, there is a desire for power supplies that can operate at high efficiency over a wide range of load conditions (e.g., from 0.5 W to the maximum load, for instance). That is, conventional power supplies need to be optimized to support ongoing green initiatives and to save money not only on electrical power consumption costs but also on carbon taxes enforced by government agencies.

Consistent with the present concepts, a haystack power supply can provide a flat haystack-shaped high efficiency curve by employing multiple converters in parallel. Using multiple converters connected in parallel to a common output, a haystack power supply can operate at high efficiency through a much wider range of output loads, thereby providing a technical solution to the technical problems described above.

For example, as illustrated in FIG. 1, the haystack power efficiency curve 100 may have a haystack shape and may start at higher efficiency than the conventional power efficiency curve 102 even at 0.5 W. Moreover, the haystack power efficiency curve 100 may stay much higher than the conventional power efficiency curve 102 on the lower end of the power output load (i.e., where the power output load is less than the peak efficiency load from about 0 W to 200 W).

In FIG. 1, a shaded region 108 below the haystack power efficiency curve 100 and the conventional power efficiency curve 102 may represent the amount of energy that could be saved using a haystack power supply consistent with the present concepts instead of a conventional power supply. In some cases, the energy savings represented by the region 108 may be higher at the lower end of the output load than the upper end.

For example, when a game console is playing a movie, the power load may be around 35 W. In this scenario, a conventional 400 W power supply may operate at a very low efficiency. Therefore, a lot of energy can be saved using a haystack power supply consistent with the present concepts. Accordingly, haystack power supplies consistent with the present concepts may have a flat haystack efficiency curve spanning an operating power range within which the power efficiency is high. Such haystack power supplies may support green initiatives, satisfy governmental regulations, and/or save on carbon taxes imposed to encourage efficient use of power.

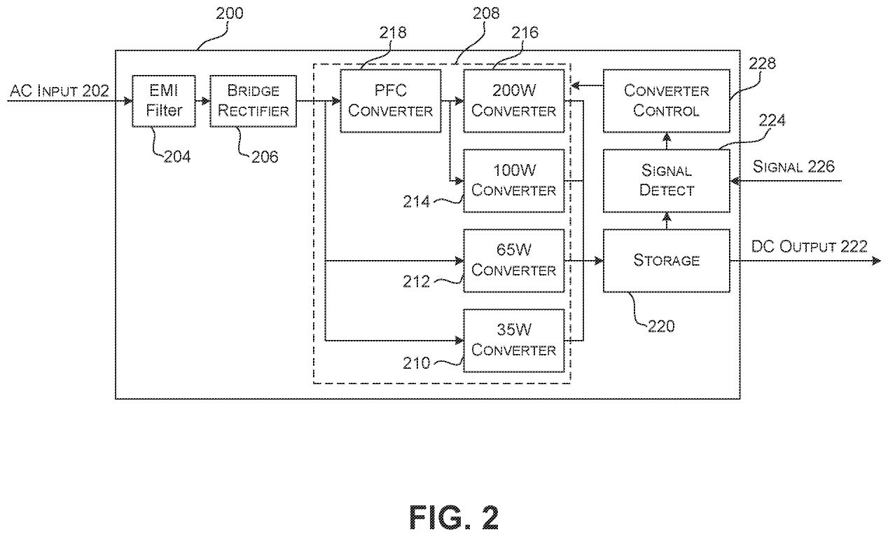

FIG. 2 illustrates a block diagram of a haystack power supply 200, consistent with some example implementations the present concepts. Power supplies may be called power supply units (PSUs), especially when they are standalone external units or distinct internal units within larger devices. Power supplies according to the present concepts may be discrete units or integrated within devices such that the boundaries between the power supplies and the devices are less defined. The present concepts will be explained with respect to the haystack power supply 200, as an example of a switched-mode power supply (SMPS). However, the present concepts may be applied to other types of power supplies.

In one example implementation, the haystack power supply 200 may receive alternating current (AC) input 202, for example, from an AC source. The haystack power supply 200 may include a noise filter, such as an electromagnetic interference (EMI) filter 204. The EMI filter 204 may filter out electromagnetic noise coming into the haystack power supply 200 from the AC source and/or filter out electromagnetic noise going out of the haystack power supply 200 to the AC source.

The haystack power supply 200 may include circuitry for converting AC power to direct current (DC) power, such as a bridge rectifier 206. The bridge rectifier 206 may convert AC to DC by flipping (or rectifying) the negative halves of the AC sine wave to a positive voltage. Therefore, the input to the bridge rectifier 206 may be a sine wave, and the output from the bridge rectifier 206 may be a chain of positive half waves.

The haystack power supply 200 may include a group of converters 208. In some implementations, the group of converters 208 may include a plurality of switching DC-to-DC converters, each of which may convert a source of DC from one voltage level to another DC voltage level.

In one example implementation, the group of converters 208 may include four DC-to-DC converters: a 35 W converter 210, a 65 W converter 212, a 100 W converter 214, and a 200 W converter 216. Four converters are included in this example for simplicity but any number of converters may be used. The power values in watts assigned to the four converters may represent their most efficient power output levels. These four DC-to-DC converters may be arranged in parallel so that the total power output of the haystack power supply 200 may be the sum of the power outputs from the individual DC-to-DC converters. For this example implementation, the 35 W converter 210 and the 65 W converter 212 may be flyback converters, and the 100 W converter 214 and the 200 W converter 216 may be inductor-inductor-capacitor (LLC) resonant converters.

Government or other regulatory authorities may mandate that a large power supply include a power factor correction (PFC) converter. For example, regulations may state that a power supply with input more than 70 W needs PFC correction, whereas a small power supply with lower than 70 W input does not need a PFC converter. Accordingly, the haystack power supply 200 in FIG. 2 may include a PFC converter 218 before the inputs to the 100 W converter 214 and the 200 W converter 216. The inputs to the 35 W converter 210 and the 65 W converter 212 may bypass the PFC converter 218 and need not be connected to the output of the PFC converter 218, unless regulations require otherwise. Since the PFC converter 218 may have losses associated with it, the PFC converter 218 may be bypassed for low power loads, if permitted.

The group of converters 208 in FIG. 2 is just one example implementation provided to explain the present concepts. Many other configurations are possible. That is, the group of converters 208 may include any number of converters, be of any type of converter, and may each provide the same power output or provide different amounts of power. For example, the group of converters 208 may include two, three, or ten converters. The group of converters 208 may include all 25 W converters or all 100 W converters, or any combination of converters of different power ratings. The group of converters 208 may include all flyback converters, all LLC converters, or any combination of any types of converters.

In the example configuration shown in FIG. 2, the haystack power supply 200 may use the two flyback converters (i.e., the 35 W converter 210 and the 65 W converter 212) for light load and medium load, and use the two LLC converters (i.e., the 100 W converter 214 and the 200 W converter 216) for heavy loads to achieve the haystack power efficiency curve 100 that resembles a haystack.

The haystack power supply 200 may include a storage 220. The group of converters 208 may individually supply DC power to the storage 220, which then may supply the DC output 222 from the haystack power supply 200 to a device (or components thereof). The storage 220 may include a capacitor (e.g., a bulk capacitor or an output reservoir capacitor) and/or a battery that may act as a charge storage for storing energy supplied to it by the group of converters 208 and in turn, supply DC power to the device. The storage 220 may absorb and store additional energy when the power supplied to it is higher than what is drawn by the DC load of the device, and may supply energy to the device load and thus progressively deplete the stored energy when the power supplied to the storage 220 is lower than what is drawn by the device. Thus, by storing DC charge, the storage 220 may provide the DC output 222 that has a smooth DC voltage (i.e., constant or steady levels of power) to the device.

The haystack power supply 200 may include a signal detect component 224. The signal detect component 224 may detect, sense, or receive a signal 226 from the device that indicates how much power the device uses. In one implementation, the signal detect component 224 may passively monitor one or more parameters of the device to determine how much power the device is using. For example, the signal detect component 224 may sense the current drawn by the device. In this scenario, the signal 226 may be the detected current. If the detected current is increasing, then the haystack power supply 200 may output more power and thus maintain the output voltage level. If the detected current is decreasing, then the haystack power supply 200 can output less power. Therefore, the haystack power supply 200 may adjust the power level of the DC output 222 in response to the sensed power utilization of the device.

In an alternative implementation, the device may actively send the haystack power supply 200 the signal 226 that indicates how much power the device is requesting. In this scenario, the signal 226 may encode a power level value. The signal detect component 224 may receive and interpret the signal 226 to determine how much power the device is requesting. Other implementations of the signal 226 are possible. For example, the signal 226 may include a set of binary flags that indicates which of the group of converters 208 to turn on or off. In the case of the group of converters 208 containing four converters, the signal 226 may include four bits, each bit indicating whether an individual converter should be turned on or off. Accordingly, the device may control the haystack power supply 200 to turn on or off the individual converters in the group of converters 208.

Alternatively, the signal 226 may indicate one of the possible numbers of power levels that the haystack power supply 200 can output. For example, if the haystack power supply 200 were capable of outputting eight different power levels based on eight different combinations of the group of converters 208 being turned on, then the signal 226 may include a number ranging from 0 to 7, corresponding to the possible power levels. In another implementation, the signal 226 may include one of a plurality of predetermined codes (e.g., “58” or “61”) that the haystack power supply 200 and the device understand and are used to communicate the desired level of power. Therefore, the device may control the power output levels of the haystack power supply 200 where the signal 226 acts as a control command. In one implementation, the signal 226 may be transmitted from the device to the haystack power supply 200 via a data transmission line, such as an inter-integrated circuit (I²C) line. The haystack power supply 200 and the device may communicate power requests using a predefined protocol, such as the universal serial bus (USB) protocol or the USB Power Delivery (USB PD) protocol, or any other protocol.

In one example implementation, the interface between the haystack power supply 200 and the device may include a low-cost 2-pin I²C type interface that includes one line for the clock and another line for the data. The interface may be used by the device to control the haystack power supply 200. The interface may be used by the device to receive power-related information from the haystack power supply 200 to feed telemetry. For instance, power-related data (e.g., the current level in amperes or the power level in watts) may be transferred from the haystack power supply 200 to the device using the interface. And then the power-related data may be transferred from the device to the cloud, for example, to assist with collecting power data in field units to gain knowledge about game play power, app power, and standby power characteristics. Such power consumption data across many devices and user usage data may help inform businesses about carbon contributions and/or validate power saving techniques deployed in the field. User usage data collection may maintain anonymity of the users, allow the users to opt in or opt out, and/or provide notices to the users for privacy purposes. Moreover, the interface may be used to receive status and/or or health information about the haystack power supply 200 to assist help desks and/or administrators.

The haystack power supply 200 may include a converter control component 228. The converter control component 228 may control the group of converters 208 by turning them on or off based on the signal 226 detected by the signal detect component 224. That is, the converter control component 228 may be capable of activating a subset of the group of converters 208, where the subset of converters may contain zero converters, one converter, multiple but less than all converters, or all of the converters. The remainder of converters, if any, that are not included in the subset of activated converters would be deactivated by the converter control component 228. The converter control component 228 may include a load balancer for activating multiple converters at the same time. Thus, the converter control component 228 may ensure that the haystack power supply 200 provides sufficient amount of power in the DC output 222 to meet the power utilization of the device by turning on one or more converters in the group of converters 208.

The storage 220, the signal detect component 224, and/or the converter control component 228 (and/or the load balancer) may be part of the haystack power supply 200, as illustrated in FIG. 2, or may be part of the device (i.e., external to the haystack power supply 200). For example, the storage 220 may be a capacitor or a battery pack of the device. Furthermore, the converter control component 228 may be implemented in the device but outside the haystack power supply 200 to control the group of converters 208 in the haystack power supply 200.

Moreover, the device may include an integrated internal power supply such that there is no defined boundary between the haystack power supply 200 and other device components. On the other hand, a desktop personal computer (PC) may have an internal discrete PSU where the boundary between the PSU and the PC is clearer, and the PSU may even have its own enclosure or casing.

The signal detect component 224 and/or the converter control component 228 may be implemented in software, firmware, and/or hardware (e.g., circuitry logic or a controller). The signal detect component 224 and the converter control component 228 may be two distinct modules or combined into one module (whether a software module or a hardware module).

In some implementations, the haystack power supply 200 may be swappable (e.g., plug-and-play) with multiple devices or at least compatible with multiple devices. Furthermore, the device may be compatible with many different types of power supplies having varying sets of converters. Alternatively, the haystack power supply 200 may be designed for a particular device.

The haystack power supply 200 and/or the device may perform an initialization procedure, including a communication handshake. The initialization procedure may involve, for example, requesting and/or sending various information, such as the available converters, the available power output levels, compatible protocols, etc. Accordingly, the device may be informed by the haystack power supply 200 of the composition of the group of converters 208, so that the device may directly control the switching on and off of the group of converters 208. That is, the load balancer of the converter control component 228 may be implemented (for example, in software) on the device.

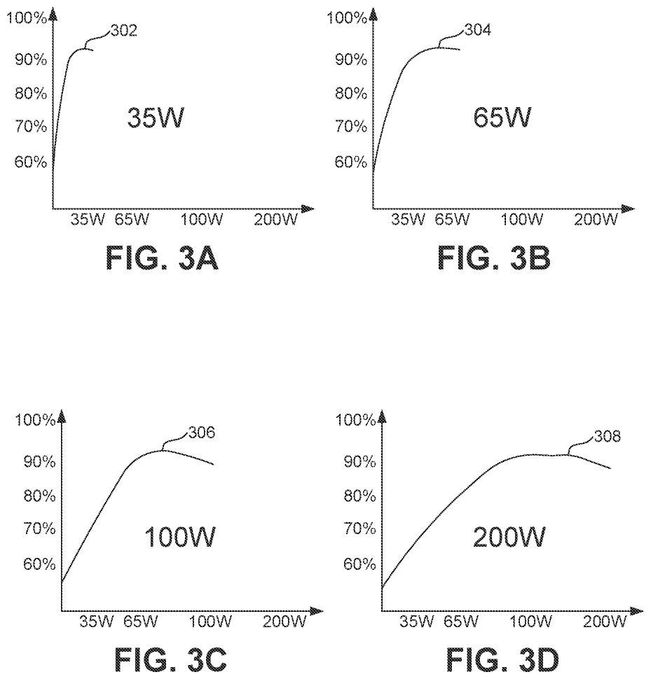

FIGS. 3A-3D illustrate example power efficiency curves of multiple converters, consistent with the present concepts. These graphs may represent the power efficiency curves of the four converters in the group of converters 208 illustrated in FIG. 2. That is, FIG. 3A shows a power efficiency curve 302 for the 35 W converter 210, FIG. 3B shows a power efficiency curve 304 for the 65 W converter 212, FIG. 3C shows a power efficiency curve 306 for the 100 W converter 214, and FIG. 3D shows a power efficiency curve 308 for the 200 W converter 216.

As illustrated, each of the four converters individually may have a hump-shaped efficiency curve that starts with very low efficiency at around 0.5 W due to losses, then rises to peak efficiency above 90% at their respective power ratings (35 W, 65 W, 100 W, or 200 W), and then falls again due to losses as the output loads increase beyond their respective peak efficiency ranges. Generally, smaller converters have smaller losses compared to larger converters at the same power output levels. Thus, smaller converters (e.g., the 35 W converter 210) have a higher power efficiency at the start (e.g., 0.5 W) compared to larger converters (e.g., the 200 W converter 216). For instance, at a specific power output level (e.g., 20 W), the 35 W converter 210 will have smaller losses than the 65 W converter 212, the 100 W converter 214, and the 200 W converter 216.

For the 35 W converter 210, at 0 W, the 35 W converter 210 may be turned off. For light loads, even below 0.5 W, the 35 W converter 210 may be activated. As illustrated in FIG. 3A, at around 0.5 W, the power efficiency curve 302 of the 35 W converter 210 may be at around 60%. Efficiency may start increasing until about 35 W, and then efficiency may start dropping. In some implementations, the smallest converter may be used to supply power for the lightest loads, because the smallest converter may be more efficient for light loads compared to larger converters.

As illustrated in FIG. 3B, for the 65 W converter 212, at around 0.5 W, the power efficiency curve 304 may be even lower than the power efficiency curve 302 of the 35 W converter 210. The power efficiency may increase until about 65 W and then may start dropping.

As illustrated in FIG. 3C, for the 100 W converter 214, at around 0.5 W, the power efficiency curve 306 may be even lower than the power efficiency curve 304 of the 65 W converter 212. The power efficiency may increase and then may start dropping after 100 W.

As illustrated in FIG. 3D, for the 200 W converter 216, at around 0.5 W, the power efficiency curve 308 may be even lower than the power efficiency curve 306 of the 100 W converter 214. The power efficiency may increase and then start dropping after 200 W.

A conventional power supply would use only one converter, perhaps one of the four converters illustrated in FIGS. 3A-3D. Therefore, conventional power supply would experience significant losses when operating at below or above its peak efficiency range. The present concepts, on the other hand, may combine these four converters into one power supply, and through selective employment of combinations of individual converters achieve the haystack power efficiency curve 100 shown in FIG. 1 throughout a wide range of power output loads.

These four specific converters are illustrated as examples to explain the present concepts. However, other implementations using different converters that are efficient at different load levels are possible. Also, there is no limit on the number of converters that may be included in the group of converters 208.

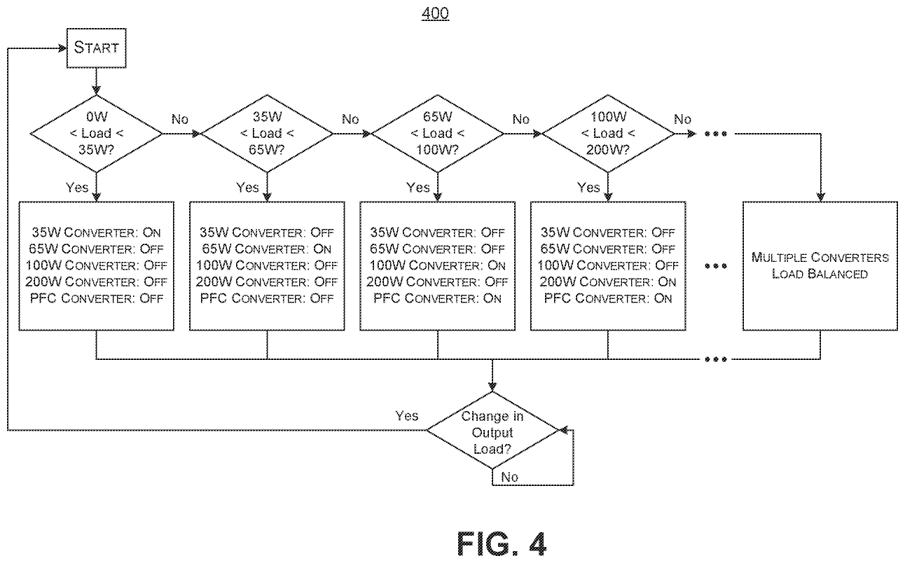

FIG. 4 illustrates a flow chart of an example converter enable and balancing logic 400, consistent with the present concepts. The converter enable and balancing logic 400 may include, for example, algorithms, configurations, and/or programming for determining which subsets of the group of converters 208 to turn on or off. The converter enable and balancing logic 400 may be implemented by, for example, the signal detect component 224 and/or the converter control component 228 of the haystack power supply 200 in FIG. 2. The flow chart in FIG. 4 illustrates an example implementation of turning on and turning off the group of converters 208 in the haystack power supply 200. As mentioned above, the individual converters in the group of converters 208 may be turned on into an active mode to supply power or turned off into an inactive mode, in which they do not supply power, by the converter control component 228 in response to the signal 226 from the device that is detected by the signal detect component 224.

As shown in FIG. 4, the converter enable and balancing logic 400 may start by determining the power load of the device. As mentioned above, the signal detect component 224 may detect the power usage by the device. For instance, the signal detect component 224 may continuously or periodically monitor the current associated with the DC output 222. Alternatively, the signal detect component 224 may receive and interpret the signal 226 sent from the device to determine the power utilization of the device.

If the signal detect component 224 determines that output load is greater than 0 W but less than 35 W, then the converter control component 228 may activate only the 35 W converter 210 and deactivate the 65 W converter 212, the 100 W converter 214, and the 200 W converter 216. For example, where the device is a laptop computer playing a video, the power output load may be around 25 W to 35 W. For small power utilization, a smaller converter, such as the 35 W converter 210 (which may be a flyback converter), may be used since, at low power, iron losses may be less and thus the power efficiency may be higher. Since the only activated converter is the 35 W converter 210, the converter control component 228 may deactivate the PFC converter 218 as unnecessary. Thus, the 35 W converter 210 may supply DC power to the storage 220 so that the haystack power supply 200 can provide power to the device based on demand. In scenarios where the lightest loads are encountered, the 35 W converter 210 may periodically turn on to charge the storage 220 (e.g., a capacitor) and turn off while the storage 220 meets the demand. By utilizing a small converter (i.e., the 35 W converter 210) when the power output load is low, the haystack power supply 200 may operate at high power efficiency, whereas a conventional 400 W power supply operating at lower power output would run at very low power efficiency and waste energy.

As shown in FIG. 4, the signal detect component 224 may continue to either monitor the power utilization of the device or receive and interpret the signal 226 from the device, and thereby determine whether the output load has changed. If the signal detect component 224 determines that the output load is greater than 35 W but less than 65 W, then the converter control component 228 may deactivate the 35 W converter 210, activate the 65 W converter 212, deactivate the 100 W converter 214, and deactivate the 200 W converter 216. Since the only activated converter is the 65 W converter 212, the converter control component 228 may also deactivate the PFC converter 218 as unnecessary. Therefore, when the load increases (e.g., from less than 35 W to more than 35 W), the haystack power supply 200 may switch from one subset of converters to another subset of converters (e.g., from using the 35 W converter 210 to using the 65 W converter 212 instead) in an attempt to maintain the voltage of the DC output 222 at the level used by the device. By switching from the 35 W converter 210 to the 65 W converter 212, the haystack power supply 200 may be able to maintain high power efficiency, whereas a conventional power supply with only a 35 W converter would experience significant losses and decrease in power efficiency as the load surpasses beyond 35 W. Moreover, a conventional 400 W power supply operating at a low power output load around 35 W to 65 W would experience low power efficiency, whereas the haystack power supply 200 using the 65 W converter 212 can output 35 W to 65 W at high power efficiency.

As the signal detect component 224 may be monitoring the output current, if the device draws more current or less current, depending on the usage of the device, the signal detect component 224 may sense the increase or decrease in the current. In response, the converter control component 228 may turn on or off certain ones of the group of converters 208 to supply more or less power to the device. In implementations where the signal detect component 224 monitors the output current and the converter control component 228 automatically switches the group of converters 208, the storage 220 may be large enough (e.g., a big enough bulk capacitor or even a battery pack) to provide sufficient energy reservoir that can supply the levels of power used by the device during the transitional periods when the group of converters 208 are being turned on or off. Therefore, a large battery may permit the group of converters 208 to switch on and off slower with longer ramp-up times.

Alternatively, in implementations where the device sends the signal 226 to the haystack power supply 200, thereby communicating how much power is used by the device, the signal 226 may be sent proactively (e.g., sufficiently in time) to cause the converter control component 228 to switch on or off the group of converters 208. For example, the device, such as a game console, may predict the load, depending on the state of the device or activities on the device, such as being in a standby mode, surfing the internet, watching a movie, or running a high-power game. For instance, a game console may know how much power certain games use and thus may signal the haystack power supply 200 to boost power by a certain amount when the game console detects that certain games are starting. In some implementations, the device may be unaware of the makeup of the group of converters 208 and thus transmit the signal 226 to the haystack power supply 200 to generally provide more power or less power. In other implementations, the device was be aware of the composition of the group of converters 208 and thus transmit the signal 226 that identifies which specific ones of the group of converters 208 to activate.

If the signal detect component 224 determines that the output load is greater than 65 W but less than 100 W, then the converter control component 228 may deactivate the 35 W converter 210, deactivate the 65 W converter 212, activate the 100 W converter 214, and deactivate the 200 W converter 216. For example, where the device is a laptop computer playing a video game, the power output load may be around 75 W to 100 W. For larger power, an LLC converter, such as the 100 W converter 214 (which may be an LLC converter), may be used since it may have low efficiency at low power but high efficiency at high power. Since the 100 W converter 214 is activated, the converter control component 228 may activate the PFC converter 218 to meet the governmental regulations.

If the signal detect component 224 determines that the output load is greater than 100 W but less than 200 W, then the converter control component 228 may deactivate the 35 W converter 210, the 65 W converter 212, and the 100 W converter 214, and activate the 200 W converter 216. Since the 200 W converter 216 is activated, the converter control component 228 may activate the PFC converter 218.

If the signal detect component 224 determines that the output load is greater than 200 W, then the converter control component 228 may implement a load balancing mode in which multiple converters in the group of converters 208 may be activated together to provide higher power output than any single converter in the group of converters 208 could alone in a single converter mode. The converter enable and balancing logic 400 may divide the range of 200 W-400 W into multiple ranges in which different combinations of the group of converters 208 may be activated to achieve the highest efficiency possible while providing enough power output.

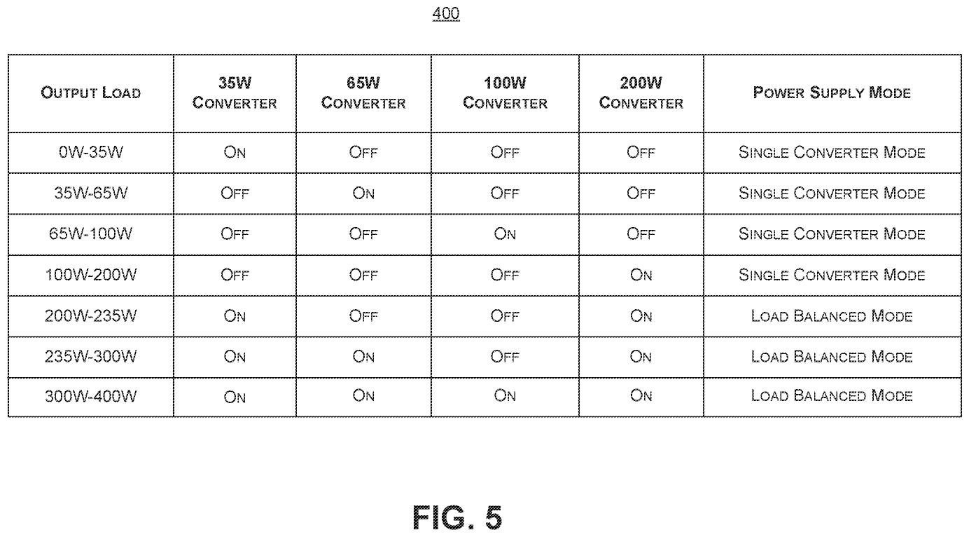

FIG. 5 illustrates a table of example modes of operation of the haystack power supply 200, consistent with the present concepts. This table demonstrates an example operation of the haystack power supply 200 at various ranges of power output load. The table in FIG. 5 may be a table format representation of the converter enable and balancing logic 400. In one example implementation explained above in connection with FIG. 4, the haystack power supply 200 may operate in the single converter mode between 0 W and 200 W, in which only one of the group of converters 208 is activated at any given time. When the output load increased above 200 W, the haystack power supply 200 may operate in the load balancing mode, in which multiple converters may be activated together at the same time. In the load balancing mode, the output power levels of the haystack power supply 200 may be the sum of the power levels from all of the activated converters.

In one example implementation illustrated in FIG. 5, the range of output load between 200 W and 400 W may be divided into the following ranges: {200 W-235 W, 235 W-300 W, 300 W-400}. If the signal detect component 224 determines that the output load is greater than 200 W but less than 235 W, then the converter control component 228 may activate the 35 W converter 210, deactivate the 65 W converter 212, deactivate the 100 W converter 214, and activate the 200 W converter 216. If the signal detect component 224 determines that output load is greater than 235 W but less than 300 W, then the converter control component 228 may activate the 35 W converter 210, activate the 65 W converter 212, deactivate the 100 W converter 214, and activate the 200 W converter 216. If the signal detect component 224 determines that output load is greater than 300 W, then the converter control component 228 may activate all of the 35 W converter 210, the 65 W converter 212, the 100 W converter 214, and the 200 W converter 216.

Whether in the single converter mode or in the load balanced mode, the PFC converter 218 may be activated whenever either the 100 W converter 214 or the 200 W converter 216 is activated. In this example implementation illustrated in FIG. 5, the haystack power supply 200 may use flyback converters (e.g., the 35 W converter 210 and/or the 65 W converters 212) for light power load levels, use LLC converters (e.g., the 100 W converter 214 and/or the 200 W converter 216) for medium load levels, and use combinations of flyback converters and LLC converters for heavy load levels. For the heaviest load, the converter control component 228 may activate all available converters, thus working together to provide the maximum power output, in this case, 400 W. For example, where the device is a laptop with a battery pack, the converter control component 228 may activate all available converters for maximum power output to rapidly charge the battery pack until it is fully charged, and then reduce the power output based on the power utilization of the device.

Many alternative implementations of the converter enable and balancing logic 400 are possible. For example, the range from 200 W to 400 W can be divided in several different ways {200 W-235 W, 235 W-300 W, 300 W-400}, {200 W-235 W, 235 W-335 W, 335 W-400 W}, {200 W-265 W, 265 W-300 W, 300 W-400 W}, {200 W-265 W, 265 W-365 W, 365 W-400 W}, {200 W-300 W, 300 W-335 W, 335 W-400 W}, or {200 W-300 W, 300 W-365 W, 365 W-400 W}. Thus, other combinations of the group of converters 208 may be activated above 200 W than the combinations described above. For example, if the output load is between 200 W and 300 W, the 100 W converter 214 and the 200 W converter 216 may be activated. If the output load is between 300 W and 335 W, then the 35 W converter 210, the 100 W converter 214, and the 200 W converter 216 may be activated.

In the example implementations of the converter enable and balancing logic 400 above, the haystack power supply 200 may operate in a single converter mode from 0 W to 200 W and may operate in a load balanced mode from 200 W to 400 W. However, alternative implementations are possible where multiples of the group of converters 208 are activated even below 200 W. For example, if the output load is between 65 W and 100 W, then the 35 W converter 210 and the 65 W converter 212 may be activated. If the output load is between 100 W and 135 W, then the 35 W converter 210 and the 100 W converter 214 may be activated. If the output load is between 135 W and 200 W, then the 35 W converter 210, the 65 W converter 212, and the 100 W converter 214 may be activated.

The specific implementation examples of the converter enable and balancing logic 400 are provided to illustrate the present concepts. However, many other variations are possible. As it should be clear, there are many different combinations of converters that can be activated together and load balanced to supply sufficient power to meet the power utilization of the device.

Furthermore, the ranges of output loads, for which different converters are activated and deactivated, may the designed into the converter enable and balancing logic 400 and programmed to achieve the highest power efficiency possible based on the individual power efficiency curves of the converters, as shown in FIGS. 3A through 3D. The converter enable and balancing logic 400 may be configured or programmed on the converter control component 228.

Additionally, the converter enable and balancing logic 400 may depend on the power ratings for the available converters in the group of converters 208. For example, if the group of converters 208 includes ten 25 W converters, then the converter control component 228 may be configured to activate or deactivate one or more of the ten 25 W converters as the output load changes between 0 W and 250 W. If the group of converters 208 includes five converters whose power ratings double (i.e., 10 W, 20 W, 40 W, 80 W, and 160 W), then these five converters may be activated and deactivated in a binary counter fashion as the output load changes from 0 W to 310 W.

In some implementations, the converter enable and balancing logic 400 may be statically set or programmed where the composition of the group of converters 208 is static. In other implementations, the converter enable and balancing logic 400 may be determined dynamically (i.e., on the fly) based on the available converters in the group of converters 208, for example, when the haystack power supply 200 is first installed, first turned on, or at each power-up.

Furthermore, the haystack power supply 200 that includes multiple converters may provide redundancy and fault tolerance in case one or more of the group of converters 208 fail. For example, if the 65 W converter 212 fails, the haystack power supply 200 may continue operating using only the 35 W converter 210, the 100 W converter 214, and the 200 W converter 216. The converter enable and balancing logic 400 may be automatically and dynamically reprogrammed to activate and deactivate the functioning converters and exclude the failed converter. Although the maximum power output of the haystack power supply 200 may be reduced from 400 W to 335 W, having the haystack power supply 200 continuing to function at a reduced maximum power level may be preferable to having no power supply at all. The haystack power supply 200 may cause an alert and/or a notification about the failed converter to be transmitted to a user or a monitoring system but nonetheless continue operating until the haystack power supply 200 or the failed converted can be fixed or replaced. In some implementations, the haystack power supply 200 may be equipped with one or more spare converters that are not used while all of the group of converters 208 are functioning but can take over in place of a failed converter.

In some implementations, the group of converters 208 may be swappable modules. That is, the haystack power supply 200 may be compatible with a wide array of devices having varying power utilization levels. The haystack power supply 200 may be customized for a particular device by installing a set of converters that is suitable for the target device. The same haystack power supply 200 may be refitted with a different set of converters to repurpose the haystack power supply 200 for a different target device. The converter enable and balancing logic 400 may be modified according to such example changes to the composition of the group of converters 208. As illustrated above, the group of converters 208 may be highly dynamic, and the converter enable and balancing logic 400 may be adaptable as well.

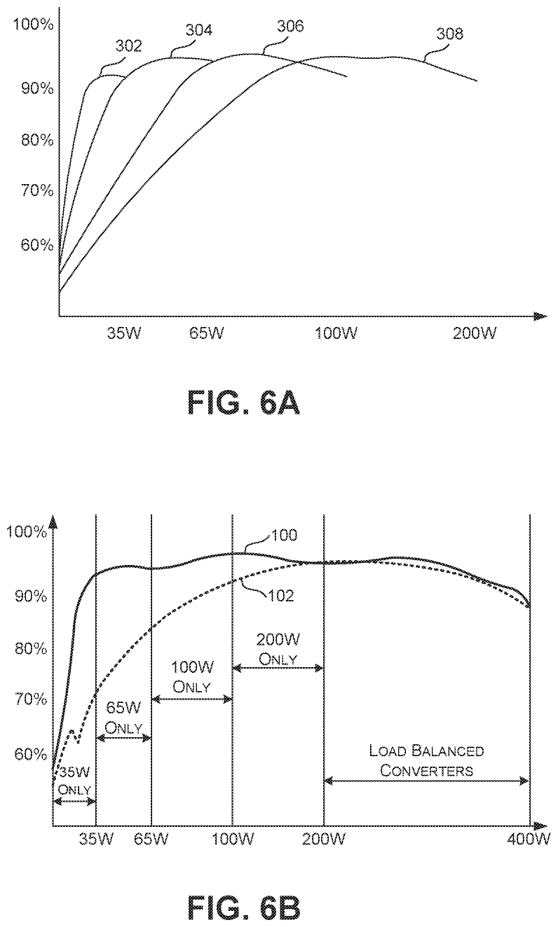

FIG. 6A illustrates the power efficiency curves 302, 304, 306, 308 in FIGS. 3A-3D of the four converters 210, 212, 214, 216 superimposed together in one graph. As illustrated, the four converters 210, 212, 214, 216 operate at peak efficiency at different power output load levels. Therefore, consistent with the present concepts, the converter control component 228 can switch among the four converters 210, 212, 214, 216 (and/or combinations of converters) to achieve high haystack efficiency across a wide range of load levels. That is, the converter control component 228 can turn on the 35 W converter 210 between 0 W and 35 W output load, turn on the 65 W converter 212 between 35 W and 65 W output load, turn on the 100 W converter 214 between 65 W and 100 W output load, and turn on the 200 W converter 216 between 100 W and 200 W output load. For example, while only the 35 W converter 210 is activated, if the power efficiency starts to drop as the output load approaches or exceeds about 35 W, then the converter control component 228 may turn off the 35 W converter 210 and turn on the 65 W converter 212.

Furthermore, at output load levels above 200 W, the converter control component 228 may employ load balancing by turning on multiple converters to achieve a haystack high efficiency curve between 200 W and 400 W. For example, while the 35 W converter 210 and the 200 W converter 216 are activated, if the power efficiency drops as the output load approaches or exceeds about 235 W, then the converter control component 228 may additionally activate the 65 W converter 212 to output additional power while maintaining high power efficiency.

FIG. 6B illustrates a comparison of the haystack power efficiency curve 100 consistent with the present concepts and the conventional power efficiency curve 102 typical of a conventional power supply. Because the converter control component 228 switches among the four converters to achieve high efficiency, the haystack power efficiency curve 100 may trace the highest portions of the four efficiency curves 302, 304, 306, 308 in FIG. 6A between 0 W and 200 W.

For example, between 0 W and 35 W output load levels, only the 35 W converter 210 may be turned on, so the haystack power efficiency curve 100 in FIG. 6B may track the power efficiency curve 302 of the 35 W converter 210 in FIG. 3A. Between 35 W and 65 W output load levels, only the 65 W converter 212 may be turned on, so the haystack power efficiency curve 100 in FIG. 6B may track the power efficiency curve 304 of the 65 W converter 212 in FIG. 3B. Accordingly, the haystack power supply 200 consistent with the present concepts may be able to maintain high power efficiency levels and avoid the typical efficiency drop that a conventional power supply using only a 35 W converter would experience. For example, where the device is a laptop computer playing a video and the power output load is around 25 W, the haystack power efficiency curve 100 of the haystack power supply 200 may be at around 90%, whereas the conventional power efficiency curve 102 may be at around 65%. Therefore, the haystack power supply 200 can provide substantial energy savings compared to a conventional power supply.

Between 65 W and 100 W output load levels, only the 100 W converter 214 may be turned on, so the haystack power efficiency curve 100 in FIG. 6B may track the power efficiency curve 306 of the 100 W converter 214 in FIG. 3C. For example, where the device is a laptop computer playing a video game and the power output load is around 75 W, the haystack power efficiency curve 100 of the haystack power supply 200 may be at around 95%, whereas the conventional power efficiency curve 102 may be at around 85%. Therefore, the haystack power supply 200 can provide energy savings compared to a conventional power supply.

Between 100 W and 200 W output load levels, only the 200 W converter 216 may be turned on, so the haystack power efficiency curve 100 in FIG. 6B may track the power efficiency curve 308 of the 200 W converter 216 in FIG. 3D. Thus, the haystack power supply 200 consistent with the present concepts may be able to maintain high efficiency levels above 90% from 0 W to 200 W using multiple converters without experiencing a drop in efficiency that a conventional power supply would.

Moreover, between 200 W and 400 W, the haystack power supply 200 of the present concepts can avoid the drop in efficiency that a conventional 200 W power supply would typically suffer. Instead, the power supply can maintain high efficiency between 200 W and 400 W by activating multiple converters at the same time in the load balanced mode. For example, between 200 W and 235 W output load levels, both the 35 W converter 210 and the 200 W converter 216 may be turned on and load balanced.

Thus, the haystack power supply 200 can achieve a high efficiency haystack curve for a much wider range of output load levels than a conventional power supply with only one converter. For example, as shown in FIG. 6B, at 65 W load, a conventional power supply would operate at about 80% efficiency, as shown by the conventional power efficiency curve 102, whereas the haystack power supply 200 would operate at about 95% efficiency, as shown by the haystack power efficiency curve 100. The difference in power efficiency levels may result in energy savings that is beneficial to the environment in reducing carbon emissions and beneficial to consumers in reducing electricity costs and/or carbon tax liabilities.

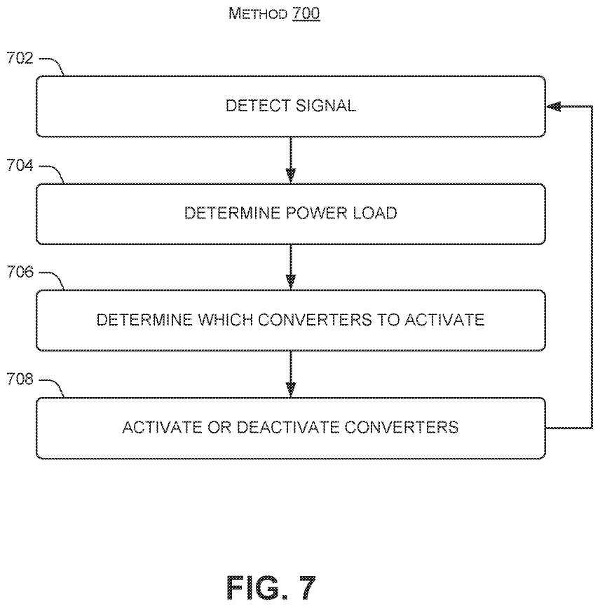

FIG. 7 illustrates a flow chart of an example power supply method 700, consistent with the present concepts. The power supply method 700 is presented for illustration purposes and is not meant to be exhaustive or limiting. The acts in the power supply method 700 may be performed in the order presented, in a different order, or in parallel or simultaneously, or may be omitted. Any or all of the acts in the power supply method 700 may be performed by a power supply or a device, or a combination of both.

In act 702, a signal may be detected. The signal may be indicative of the power load of a device. For instance, a power supply may monitor or sense one or more parameters of a device that relate to the current or future power consumption by the device. Such parameters may include, for example, CPU usage, memory usage, network usage, storage reads and/or writes, display brightness, display refresh rate, the type and number of applications running or being launched, current, voltage, power, etc.

In one implementation, the power supply may sense the current, which may change depending on the power load of the device. As the device consumes more power and draws more current, the power supply can detect the change in current. Conversely, as the device consumes less power and draws less current, the power supply may detect such a change.

Alternatively, a signal that has been sent by the device to the power supply may be received. The device may determine the current or future power utilization, for example, based on one or more of the parameters listed above. The device may encode and transmit a signal to the power supply to control the level of power output by the power supply.

In act 704, the power supply may determine the power load of the device. For instance, where the power supply is monitoring the current drawn by the device, the power supply may calculate the power load based on the detected current. In an alternative implementation, the power supply may decode the signal received from the device to determine the power load of the device. For example, the power supply and the device may communicate with each other using a predetermined protocol. The protocol may permit the device to send to the power supply an encoded power value or any other mutually understood value that reflects the power load level.

In act 706, the converters to be activated or deactivated may be determined. Depending on the power ratings for the available converters, the power supply may determine one converter or a combination of multiple converters that can be activated to meet the power load determined in the act 704 at the highest possible power efficiency. For example, if the power load determined in the act 704 were 90 W, then the power supply may determine which of the available converters can be activated to provide sufficient level of output power to meet or exceed the 90 W power load of the device. For example, the power supply may determine that activating a single 90 W converter, a single 100 W converter, a combination of a 30 W converter and a 70 W converter, or any other available set of one or more converters will sufficiently meet the power load. There may be larger converters (e.g., a 200 W converter) that could meet the power load but would do so at a lower power efficiency. Thus, the power supply may select a set of one or more converters that would meet the power load at the highest power efficiency among all available sets of converters that could meet the load.

In act 708, the set of converters determined in the act 706 may be activated and the rest of the converters deactivated. Accordingly, the set of activated converters may supply power to the device.

The acts 702 through 708 may be repeated continuously or periodically so that the power supply can provide sufficient power to the device as the power load changes.

In one implementation, the device may be aware of the available converters and determine which of the available converters should be activated or deactivated to meet the power demands. In turn, the device may send a signal to the power supply specifying which of the converters the power supply should activate or deactivate. In this scenario, the power supply may skip the act 706 since the determination was already made by the device.

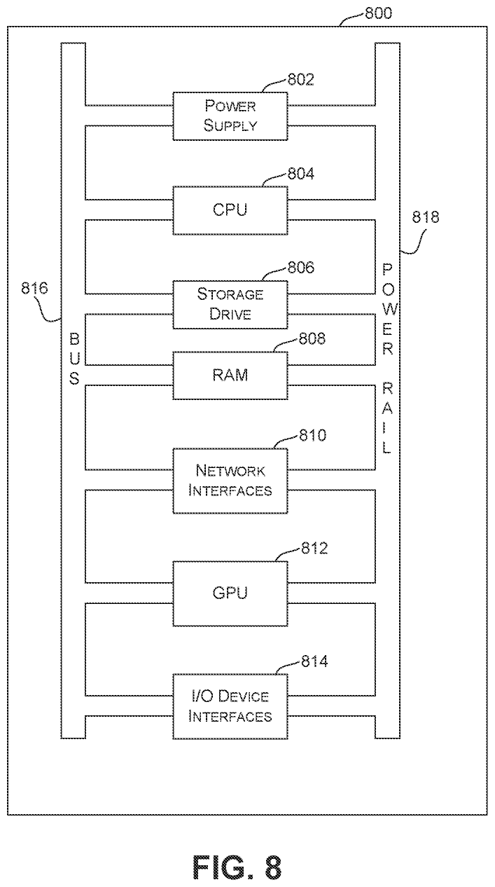

FIG. 8 illustrates an example device 800, consistent with the present concepts. The device 800 may be any system that consumes DC power converted from an AC source by a power supply 802 or any system that uses an AC source to charge a battery that supplies DC power. For example, the device 800 may include a server, mainframe computer, workstation, desktop personal computer (“PC”), laptop, notebook, tablet, smartphone, video game console, appliance, appliance console, kiosk, automobile, automobile navigation or entertainment system, virtual reality simulator, wearable, printer, television, camera, programmable electronics, etc.

The advantages of the present concepts may be realized for devices that have a varying power usage range. For example, a printer that consumes low power when idle and consumes high power when printing or a notebook that consumes low power when browsing the internet and consumes high power when playing a video game can use the power supply 802 to operate at a higher efficiency than a conventional power supply during low power modes. The device 800 in FIG. 8 is provided as an example to illustrate an implementation of the present concepts. Variations and alternative configurations are possible.

The term “device,” “computer,” or “computing device” as used herein can mean any type of device that has processing capability and/or storage capability. Processing capability can be provided by circuit logic or a hardware processor that can execute data in the form of computer-readable instructions to provide a functionality.

The power supply 802 may receive power from an AC source, convert AC to DC, and supply DC power to the device 800 and to its components that use DC power. For example, the power supply 802 may be the haystack power supply 200 in FIG. 2. Although the power supply 802 is illustrated in FIG. 8 as a discrete unit inside the device 800, the power supply 802 may be external to the device 800 or may be internal but not necessarily a separate, distinct, and discrete unit within the device 800. Furthermore, the device 800 may include multiple power supplies, or one power supply may power multiple devices.

The device 800 may include one or more components of various types, depending on the nature, type, purpose, and/or function of the device 800. For example, the device 800 may include a central processing unit (CPU) 804 for executing instructions, for example, machine-executable instructions that implement various aspects of the present concepts described herein. Although only one CPU 804 is shown in FIG. 8 for simplicity, the device 800 may include multiple CPUs. The CPU 804 may be a single processor, a multi-processor, single-core units, and/or multi-core units. The CPU 804 may perform processing to implement the present concepts, including all or part of the power supply method 700. For instance, the CPU 804 may send the signal 226 to the power supply 802 to control the level of power provided by the power supply 802. Furthermore, the power supply 802 may include a processor, similar to the CPU 804, for detecting and processing the signal 226 and/or controlling the group of converters 208. The processor of the power supply 802 and the CPU 804 of the device 800 may communicate with each other and work together to implement the present concepts.

The device 800 may include a storage drive 806 for storing data, including programs, applications, operating systems, other machine-executable instructions, and/or user-related data. The storage drive 806 may include computer readable storage media, such as magnetic disks, optical disks, solid state drives, removable memory, external memory, flash memory, volatile or non-volatile memory, hard drives, optical storage devices (e.g., CDs, DVDs etc.), and/or remote storage (e.g., cloud-based storage), among others. The storage drive 806 may be internal or external to the device 800. Computer readable storage media can be any available media for storing information without employing transitory propagated signals. The storage drive 806 may store instructions and/or data (e.g., textures, mipmaps, meshes, audio files, etc.) for implementing the present concepts, including all or a part of the power supply method 700. Furthermore, the power supply 802 may include a storage drive, similar to the storage drive 806, for storing the converter enable and balancing logic 400 and/or instructions for detecting and processing the signal 226 and/or controlling the group of converters 208.

The device 800 may include random access memory (RAM) 808 for loading active data, programs, applications, operating systems, and/or other machine executable instructions from the storage drive 806. The RAM 808 may be volatile and/or non-volatile memory. The RAM 808 may be used by the CPU 804 to load, access, and manipulate instructions and/or data for implementing the present concepts.

The device 800 may include one or more network interfaces 810 for interfacing with one or more networks to communicate with other computers or devices (e.g., networked storage, networked display, etc.). The network interfaces 810 can include wired network interfaces for connecting to wired networks (e.g., ethernet), and can also include wireless network interfaces for connecting to wireless networks (e.g., Wi-Fi, Bluetooth, cellular, etc.). In some implementations, the device 800 may communicate with other devices (that may or may not share the power supply 802) using the network interfaces 810 to implement all or part of the present concepts.

The device 800 may include a graphics processing unit (GPU) 812 for executing instructions related to graphics and for displaying graphics on a display screen. The GPU 812 may reside on a graphics card that is connected to an on-board display or an external display, and may include an interface for sending video signals to the display. The graphics card may also include graphics memory for storing instructions and/or data related to graphics. Alternatively, the GPU 812 may reside on the same board as the CPU 804. Although FIG. 8 illustrates the GPU 812 and the CPU 804 separately, the GPU 812 may be an integrated GPU that is on the same die as the CPU 804, for example, in a system on a chip (SoC). Although FIG. 8 illustrates only one GPU 812, the device 800 may include multiple GPUs. The GPU 812 may be a single processor, a multi-processor, single-core units, and/or multi-core units.

The device 800 may include input/output (“I/O”) device interfaces 814 for interfacing with one or more I/O devices, such as a keyboard, mouse, track pad, speaker, microphone, printer, scanner, facsimile machine, camera, remote control, joystick, game pad, stylus, touch screen, etc. A user or a computer may provide input to the device 800 or receive output from the device 800 using one or more of these I/O devices.

The device 800 may include a bus 816. The bus 816 may include multiple signal lines that connect various components of the device 800 and provide interfaces for those components to communicate and transfer signals and/or data among one another. For example, in some implementations, the bus 816 may be used by the CPU 804 to query the utilization levels or power consumption levels of the various components in the device 800, and the bus 816 may be used by the various components to report their power usage to the CPU 804. Furthermore, the bus 816 may be used by the CPU 804 to transmit the signal 226 to the power supply 802.

The device 800 may include a power rail 818. The power rail 818 may include multiple power lines that connect various components of the device 800 to the power supply 802. The power rail 818 may be used by the power supply 802 to supply power to the various components of the device 800. For example, the DC output 222 in FIG. 2 may be supplied to the power rail 818 in FIG. 8. Furthermore, in some implementations, the signal detect component 224 may sense the current on the one or more lines of the power rail 818.

The device 800 illustrated in FIG. 8 is merely one example. Many other types and configurations of the device 800 are possible. The device 800 may not include all or any of the components described above. The number and the types of components in the device 800 can vary widely, as the application of the power supply 802 is virtually universal. The power supply 802 and/or the device 800 may execute all or a part of the power supply method 700.

Generally, any of the functions described herein can be implemented using software, firmware, hardware (e.g., fixed-logic circuitry), or a combination of these implementations. The term “component,” “module,” or “logic” as used herein generally may represent software, firmware, hardware, circuitry, whole devices or networks, or a combination thereof. In the case of a software implementation of an aspect of the present concepts, these may represent program code that performs specified tasks when executed by a processor. The program code can be stored in one or more computer-readable memory devices, such as computer-readable storage media. The features and techniques of the component, module, or logic may be platform-independent, meaning that they may be implemented on a variety of commercial computing platforms having a variety of processing configurations.

Various examples are described above. Additional examples are described below. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

Various examples are described above. Additional examples are described below. One example includes a device comprising components that consume a level of power, a power supply including a plurality of converters connected in parallel, the power supply having a haystack power efficiency curve spanning a wider range of power output levels than a power efficiency curve of any one of the plurality of converters, and a controller for activating a subset of the plurality of converters to cause the power supply to supply at least the level of power to the components.

Another example can include any of the above and/or below examples where a power output level of the power supply includes a sum of one or more power output levels of the subset of the plurality of converters that is activated.

Another example can include any of the above and/or below examples where the plurality of converters have different peak efficiency power output levels.

Another example can include any of the above and/or below examples where the device further comprises a storage where the subset of the plurality of converters that is activated supplies power to the storage.

Another example can include any of the above and/or below examples where the storage is a bulk capacitor.

Another example can include any of the above and/or below examples where the storage is a battery.

Another example can include any of the above and/or below examples where the device further comprises a signal detector for monitoring a current drawn by the device the controller determines the subset of the plurality of converters based on the current.

Another example can include any of the above and/or below examples where the device further comprises a signal detector for receiving a power value from the device where the controller determines the subset of the plurality of converters based on the power value.

Another example can include a method comprising determining a power load of a device based on a signal, activating a first subset of a plurality of converters that are connected in parallel to supply a combined power output that meets the power load of the device, and deactivating a second subset of the plurality of converters.

Another example can include any of the above and/or below examples where the signal is received from the device.

Another example can include any of the above and/or below examples where the method further comprises determining the first subset of the plurality of converters to activate and the second subset of the plurality of converters to deactivate based on the signal.

Another example can include any of the above and/or below examples where the method further comprises monitoring the device to detect a change in the signal.

Another example can include any of the above and/or below examples where the method further comprises modifying the first subset and the second subset based on the change in the signal.

Another example can include any of the above and/or below examples where the first subset includes only one of the plurality of converters.

Another example can include any of the above and/or below examples where the first subset includes two or more of the plurality of converters.

Another example can include any of the above and/or below examples where wherein the combined power output includes a sum of one or more individual power outputs from the first subset of the plurality of converter.

Another example can include a system comprising a first converter capable of supplying a first power level, a second converter capable of supplying a second power level, the first converter and the second converter being connected in parallel, and the system outputting a combined power level being a sum of the first power level and the second power level.

Another example can include any of the above and/or below examples where the system further comprises a single converter mode in which only one of the first converter and the second converter is activated and a load balanced mode in which both the first converter and the second converter are activated.

Another example can include any of the above and/or below examples where the system further comprises a PFC converter connected in series with the second converter, the first converter bypassing the PFC converter.

Another example can include any of the above and/or below examples where the first converter is a flyback converter and the second converter is an LLC converter.

1. A device comprising:
components that consume a level of power;
a power supply including a plurality of converters connected in parallel, the power supply having a haystack power efficiency curve spanning a wider range of power output levels than a power efficiency curve of any one of the plurality of converters; and
a controller for activating a subset of the plurality of converters to cause the power supply to supply at least the level of power to the components.

2. The device of claim 1, wherein a power output level of the power supply includes a sum of one or more power output levels of the subset of the plurality of converters that is activated.

3. The device of claim 1, wherein the plurality of converters have different peak efficiency power output levels.

4. The device of claim 1, further comprising:
a storage,
wherein the subset of the plurality of converters that is activated supplies power to the storage.

5. The device of claim 4, wherein the storage is a bulk capacitor.

6. The device of claim 4, wherein the storage is a battery.

7. The device of claim 1, further comprising:
a signal detector for monitoring a current drawn by the device,
wherein the controller determines the subset of the plurality of converters based on the current.

8. The device of claim 1, further comprising:
a signal detector for receiving a power value from the device,
wherein the controller determines the subset of the plurality of converters based on the power value.

9. A method, comprising:
determining a power load of a device based on a signal;
activating a first subset of a plurality of converters that are connected in parallel to supply a combined power output that meets the power load of the device; and
deactivating a second subset of the plurality of converters.

10. The method of claim 9, wherein the signal is received from the device.

11. The method of claim 9, further comprising:
determining the first subset of the plurality of converters to activate and the second subset of the plurality of converters to deactivate based on the signal.

12. The method of claim 9, further comprising:
monitoring the device to detect a change in the signal.

13. The method of claim 12, further comprising:
modifying the first subset and the second subset based on the change in the signal.

14. The method of claim 9, wherein the first subset includes only one of the plurality of converters.

15. The method of claim 9, wherein the first subset includes two or more of the plurality of converters.

16. The method of claim 9, wherein the combined power output includes a sum of one or more individual power outputs from the first subset of the plurality of converters.

17. A system, comprising:
a first converter capable of supplying a first power level; and
a second converter capable of supplying a second power level, the first converter and the second converter being connected in parallel,
the system outputting a combined power level being a sum of the first power level and the second power level.

18. The system of claim 17, further comprising:
a single converter mode in which only one of the first converter and the second converter is activated; and
a load balanced mode in which both the first converter and the second converter are activated.

19. The system of claim 17, further comprising:
a PFC converter connected in series with the second converter, the first converter bypassing the PFC converter.

20. The system of claim 17, wherein the first converter is a flyback converter and the second converter is an LLC converter.
